(19) United States
(12) Patent Application Publication
(10) Pub. No.: US 2026/0090575 A1
(43) Pub. Date: Apr. 2, 2026

(54) Camu Camu Food Product and Method of Making

(71) Applicant: Jeffrey Moats, Naples, FL (US)

(72) Inventor: Jeffrey Moats, Naples, FL (US)

(21) Appl. No.: 19/253,295

(22) Filed: Jun. 27, 2025

Related U.S. Application Data
(60) Provisional application No. 63/701,334, filed on Sep. 30, 2024.

(51) Int. Cl. A23L 19/00; A23L 29/00; A23L 33/15; A23L 33/175

(52) U.S. Cl. CPC A23L 19/01; A23L 29/035; A23L 33/15; A23L 33/175

(57) ABSTRACT

Provided herein is a camu camu food product and/or a nutraceutical prepared from the whole fruit including the skin, the pulp and the seeds. Also provided is a process to prepare the whole fruit as the food product and/or the nutraceutical.

### CROSS-REFERENCE TO RELATED APPLICATIONS

This non-provisional patent application claims benefit of priority under 35 U.S.C. § 119(e) of provisional application U.S. Ser. No. 63/701,334, filed Sep. 30, 2024, the entirety of which is hereby incorporated by reference.

### BACKGROUND OF THE INVENTION

### Field of the Invention

The present invention relates to the fields of food products and nutraceuticals and the processing thereof. More specifically, the present invention relates to food products and nutraceuticals processed from camu camu fruit (Myrciaria dubia) and preparation methods thereof.

### Description of the Related Art

The fruit of the Myrciaria dubia tree, commonly known as camu camu, is widely known for its vitamin C and other nutrient content and health benefits. The fruit is tart and it is found in supplement form as powders, pills or as a juice. Current methods of processing the fruit to a powder removes the seeds which contain compounds and nutrients not found in the skin or pulp. Freeze-drying or spray-drying the remaining skin and pulp also destroys nutrients and lowers their individual and collective efficacy.

Thus, there is a need in the art for processes to prepare camu camu powdered food products that incorporate the entirety of the fruit and retain the entirety of its compound matrix and nutrients. Particularly, the prior art is deficient in a camu camu food product processed from the whole fruit including the seeds as a powder without freeze- or spray-drying. The present invention fulfills this longstanding need and desire in the art.

### SUMMARY OF THE INVENTION

The present invention is directed to a food product comprising a powdered extract of a whole camu camu fruit.

The present invention also is directed to a method for preparing a food product from camu camu. In this method, a camu camu fruit puree is milled at least once in a colloidal mill to produce a fruit puree with a reduced particle size to increase dissolvability and absorption. The fruit puree is spread on an infrared-transparent conveyor belt floating on the surface of circulating water heated to a low temperature. Water content of the fruit puree is evaporated until a dry powder extract is produced and the dry powder extract is collected. The dry powder extract is milled at least once until particle size therein is at a smallest size, thereby preparing the food product from camu camu.

The present invention is directed further to a camu camu food product prepared by the method as described herein.

The present invention is directed further still to a process for preparing an arginine-enriched camu camu nutraceutical. In this process, skin, pulp and seeds of a camu camu fruit are pureed and a layer of puree is spread onto an infrared-transparent surface floating on water that is circulated and heated to a temperature less than boiling. Thermal energy radiates through the infrared-transparent surface and the puree to evaporate the water therefrom to form a dry powder extract, where the dry powder extract comprises the arginine-enriched camu camu nutraceutical.

The present invention is directed to a related method further comprising milling the dry powder extract to reduce particle size thereof to increase dissolvability and a faster absorption.

The present invention is directed further still to an arginine-enriched camu camu nutraceutical produced by the process.

The present invention is directed further still to a nutraceutical prepared from a puree of pulp, skin and seeds of a camu camu fruit to retain an entirety of nutrients therein via a thermal condensing of the puree at a low temperature to form a dry powder.

Other and further aspects, features, benefits, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 is a cartoon illustrating the drying process to produce the dried camu camu powder extract.

FIG. 2 is an ¹H-NMR spectrum of a camu camu sample. The numbered signals identify the molecules listed in Table 1.

### DETAILED DESCRIPTION OF THE INVENTION

The articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “or” in the claims refers to “and/or” unless explicitly indicated to refer to alternatives only or the alternatives are mutually exclusive, although the disclosure supports a definition that refers to only alternatives and “and/or”.

The terms “comprise” and “comprising” are used in the inclusive, open sense, meaning that additional elements may be included.

The terms “consist of” and “consisting of” are used in the exclusive, closed sense, meaning that additional elements may not be included.

The term “including” is used herein to mean “including, but not limited to”. “Including” and “including but not limited to” are used interchangeably.

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, the terms “extract”, “powdered extract” and “dry powder extract are used interchangeably and refer to a food product or nutraceutical prepared from camu camu that contains the beneficial biochemicals, such as, but not limited to, arginine, found in the fruit.

As used herein, the terms “food product” and “nutraceutical” are interchangeable in so far as a food product may contain a nutraceutical or be a nutraceutical.

As used herein, the term “thermal condensing” refers to evaporating water from the camu camu puree via infrared thermal energy at temperatures less than boiling until the puree is a dry powdered extract whereby the cell structure thereof remains intact.

As used herein, the term “low temperature” refers to a temperature that is less than the temperature at which water boils.

In one embodiment of the present invention, there is provided a food product comprising a powdered extract of a whole camu camu fruit. In this embodiment, the powdered extract may comprise skin, pulp and seeds of the camu camu fruit evaporatively dried with infrared thermal energy. Also, in this embodiment, the powdered extract may be L-arginine enriched. In addition, the food product may comprise a nutraceutical.

In another embodiment of the present invention, there is provided a method for preparing a food product from camu camu, comprising milling at least once in a colloidal mill a camu camu fruit puree to produce a fruit puree with a reduced particle size to increase dissolvability and absorption; spreading the fruit puree on an infrared-transparent conveyor belt floating on the surface of circulating water heated to a low temperature; evaporating water content of the fruit puree until a dry powder extract is produced; collecting the dry powder extract, thereby preparing the food product from Camu camu; and milling the dry powder extract at least once until particle size therein is at a smallest size.

In this embodiment, the milling step may comprise milling seeds contained within the camu camu fruit with the skin and the pulp. Also in this embodiment, the circulating water may have a temperature less than boiling. Particularly, the temperature of the circulating water is less than or equal to 96° F. In addition, the evaporating step may comprise conducting thermal energy from the heated circulating water through the infrared-transparent conveyor belt and the fruit puree, where the thermal energy evaporates water content of the fruit puree. In addition, during the evaporating step, temperature of the fruit puree as it dries does not exceed about 96° F. Furthermore, the fruit puree contains all parts of the camu camu fruit.

In yet another embodiment of the present invention, there is provided a camu camu food product prepared by the method as described supra. In this embodiment, the camu camu food product may comprise a dried whole fruit extract of pulp, skin and seeds. Also in this embodiment, the food product may be enriched in at least L-arginine and vitamin C. Further to this embodiment the food product may be enriched in ellagic acid, flavonoids or polyphenolics or a combination thereof.

In yet another embodiment of the present invention, there is provided a process for preparing an arginine-enriched camu camu nutraceutical, comprising pureeing skin, pulp and seeds of a camu camu fruit; and spreading a layer of puree onto an infrared-transparent surface floating on water that is circulated and heated to a temperature less than boiling; radiating thermal energy through the infrared-transparent surface and the puree to evaporate the water therefrom to form a dry powder extract, where the dry powder extract comprises the arginine-enriched camu camu nutraceutical. Further to this embodiment, the method comprises milling the dry powder extract to reduce particle size thereof to increase dissolvability and a faster absorption. In both embodiments, during the radiating step, temperature of the puree as the water evaporates therefrom does not exceed 96° F.

In yet another embodiment of the present invention, there is provided an arginine-enriched camu camu nutraceutical produced by the process as described supra. Further to this embodiment the arginine-enriched camu camu nutraceutical may be enriched with vitamin C, ellagic acid, flavonoids or polyphenolics or a combination thereof.

In yet another embodiment of the present invention, there is provided a nutraceutical prepared from a puree of pulp, skin and seeds of a camu camu fruit to retain an entirety of nutrients therein via a thermal condensing at a low temperature of the puree to form a dry powder.

In this embodiment the dry powder may retain arginine and ascorbic acid. Further to this embodiment the dry powder may retain at least one of ellagic acid, flavonoids or polyphenolics. In all embodiments the nutraceutical may be prepared at the low temperature of 96° F. or less. Also, the nutraceutical may be contained in a food product as a component thereof.

Provided herein is a food product and a nutraceutical comprising a powdered extract of camu camu whole fruit dried to contain the entirety of the skin, the pulp and the seeds. Unlike camu camu powders known in the art, the food product produced herein is the first to include the seeds which substantially changes the chemical composition of the extract and enriches the extract with efficacious compounds not found in the pulp or skin of the camu camu fruit. The cell structure of the product is condensed, not exploded as in other technologies, thereby retaining all nutrients in the cell. The food product may comprise, contain or consist of the nutraceutical.

Also provided is a method or process for preparing the food product or nutraceutical. The method provided herein is useful for heat-sensitive foods, such as fruits and vegetables. Because the powdered extract contains the seeds, this woody material requires extra processing to reduce its particle size to improve its dissolvability. The camu camu fruit is passed through a disintegrator or colloidal mill at least once to form a wet puree in which the particle size is reduced before the purée is dried (Example 1) and collected and milled again at least once to reduce the dry powder particles to as small a size as possible to produce its final powder form or extract.

The drying process provided herein has advantages over freeze drying and spray drying and is particularly useful for drying fruits and vegetables due to its low temperature that is less than boiling, for example, but not limited to, 96° F. Firstly, it is a gentle drying process that preserves the nutritional value and sensory qualities of the food product. Secondly, it is an energy-efficient drying process. Thirdly, the drying process is a continuous drying process able to dry large quantities of the puree quickly and efficiently in bulk via thermal condensing of the puree to remove the water while maintaining the cell structure and nutrient content.

The following examples are given for the purpose of illustrating various embodiments of the invention and are not meant to limit the present invention in any fashion.

### Example 1

### Drying Process for Camu Camu Food Product

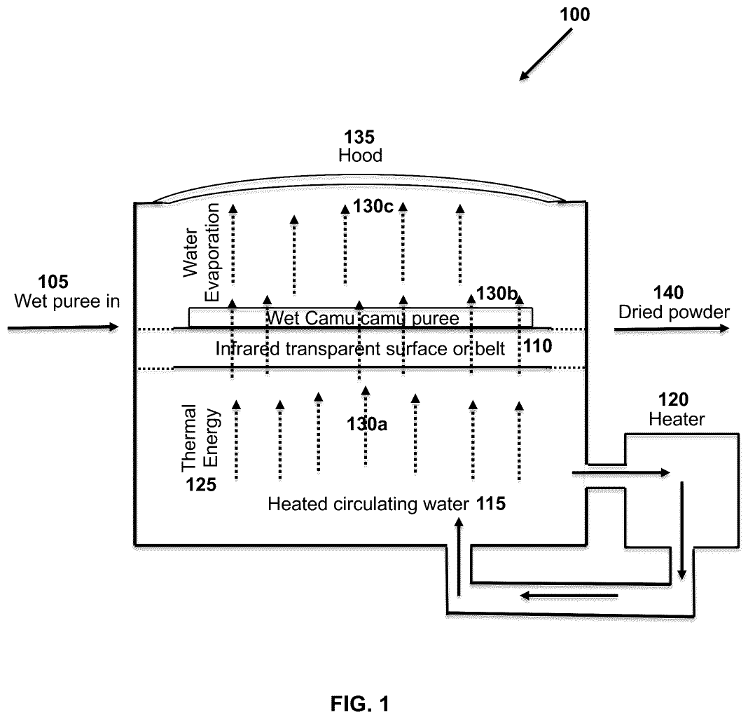

After the whole camu camu fruit is milled with a colloidal mill at least once, preferably twice, or disintegrated by other means to reduce the seeds to smaller particulates in a wet puree with the skin and pulp, the wet puree is dried using the following procedure 100 (FIG. 1).
1) The wet puree 105 is applied as a film to the upper surface of an infrared-transparent, plastic conveyor belt 110, such as, but not limited to, mylar.
2) The conveyor belt floats on the surface of circulating water 115 heated to a temperature less than boiling, for example, to a maximum of 96° F. via a heater 120.
3) Thermal energy 125 from the heated water below the belt travels upwards at 130a.
4) The water content of the puree conducts this energy through the belt and thus the puree at 130b, allowing for its own water content to evaporate.
5) The evaporated water vapor 130c is exhausted through a stainless steel hood 135 that is located at the top of the film.
6) The resulting dried powdered extract 140 is collected at the end of the conveyor belt as the food product.
7) The dried powdered extract is milled at least once until the particles are reduced to the smallest size possible.

The wet puree is never put under a vacuum during drying. Moreover, the temperature of the wet puree as it dries never reaches the temperature of the heated circulating water underneath the conveyor belt because evaporation cools it as it dries.

In this drying system, nor is the drying puree exposed to ambient air because the vapor pressure from evaporation drives away the surrounding air or oxygen, keeping the puree from oxidizing as it dries.

### Example 2

### 1H-NMR Demonstrating the Presence of Arginine

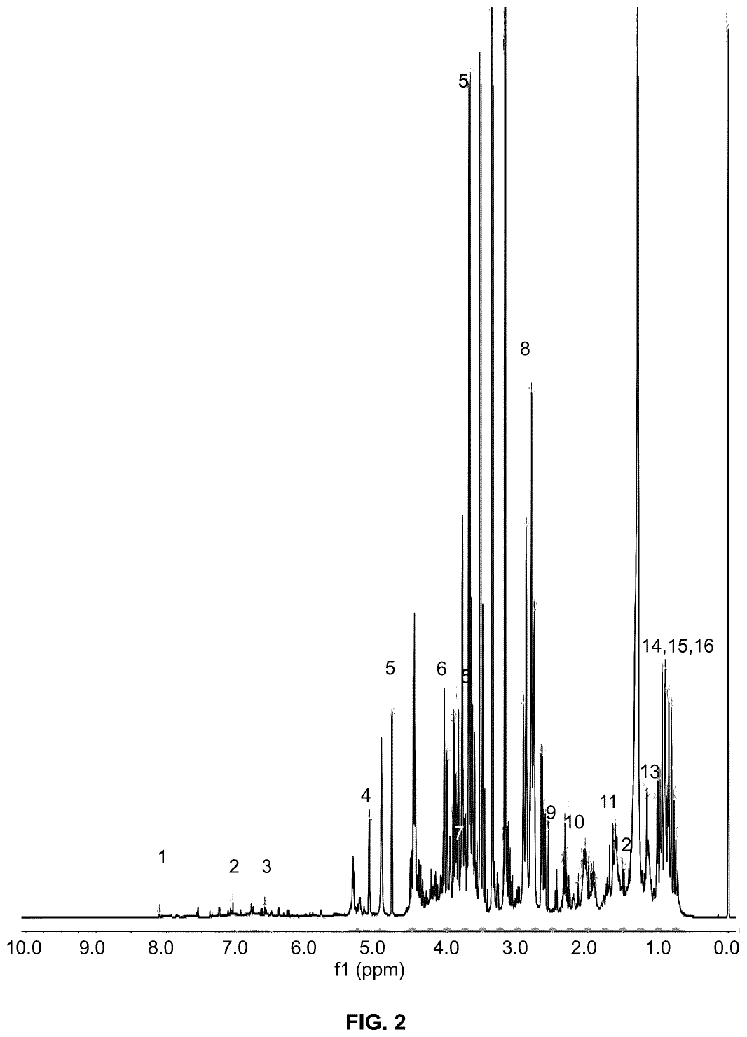

FIG. 2 is the 1H-NMR spectrum of camu camu at δ 0.0-10.0 ppm shows characteristic signals for primary and secondary metabolites. 300 mg of homogenized tissues was dissolved in 2 ml of deuterated methanol (CD₃OD) chosen for its greater solubility towards diverse chemical compounds. Samples were incubated in the sonicating bath for 30 min at room temperature. Sonicated samples were centrifuged for 15 min at 6000 rpm, and then 650 μL of clear supernatant was collected in an NMR tube. 1H-NMR spectra were acquired using 400 MHz Bruker Avance III NMR equipped with a 5 mm “BBI” room temperature probe. Table 1 is the list of molecules observed from 1H-NMR as numbered in the spectrum (FIG. 2).

TABLE 1
Signals for primary and secondary metabolites of camu camu

| | | Chemical shifts - ppm |
|---|---|---|
| Number | Molecule | (multiplicity) |
| 1 | Formic acid | 8.10 (s) |
| 2 | Gallic acid | 7.05 (s) |
| 3 | Fumaric acid | 6.60 (s) |
| 4 | alpha-Glucose | 5.11 (s) |
| 5 | Ascorbic acid | 4.79 (d) |
| 6 | Fructose | 4.01 (s) |
| 7 | Choline | 3.20 (s) |
| 8 | Citric acid | 2.62 and 2.8 (dd) |
| 9 | Succinic acid | 2.56 (s) |
| 10 | Proline | 2.03 and 2.35 (m) |
| 11 | Arginine | 1.59 and 1.61 (m) |
| 12 | Alanine | 1.49 (d) |
| 13 | Threonine | 1.17 (d) |
| 14 | Valine | 0.99 (d) |
| 15 | Isoleucine | 0.93 (m) |
| 16 | Leucine | 0.85 (m) |

What is claimed is:

1. A food product comprising a powdered extract of a whole camu camu fruit.

2. The food product of claim 1, said powdered extract comprising skin, pulp and seeds of the camu camu fruit evaporatively dried with infrared thermal energy.

3. The food product of claim 1, wherein the powdered extract is L-arginine enriched.

4. The food product of claim 1, comprising a nutraceutical.

5. A method for preparing a food product from camu camu, comprising:
milling at least once in a colloidal mill a camu camu fruit puree to produce a fruit puree with a reduced particle size to increase dissolvability and absorption;
spreading the fruit puree on an infrared-transparent conveyor belt floating on the surface of circulating water heated to a low temperature;
evaporating water content of the fruit puree until a dry powder extract is produced;
collecting the dry powder extract; and
milling the dry powder extract at least once until particle size therein is at a smallest size, thereby preparing the food product from Camu camu.

6. The method of claim 5, wherein the milling step comprises:
milling seeds contained within the camu camu fruit with the skin and the pulp.

7. The method of claim 5, wherein the circulating water has a temperature less than boiling.

8. The method of claim 7, wherein the temperature of the circulating water is less than or equal to 96° F.

9. The method of claim 5, wherein the evaporating step comprises
conducting thermal energy from the heated circulating water through the infrared-transparent conveyor belt and the fruit puree, said thermal energy evaporating water content of the fruit puree.

10. The method of claim 5, wherein during the evaporating step, temperature of the fruit puree as it dries does not exceed 96° F.

11. The method of claim 5, wherein the fruit puree contains all parts of the camu camu fruit.

12. A camu camu food product prepared by the method of claim 5.

13. The camu camu food product of claim 12, comprising a dried whole fruit extract of pulp, skin and seeds.

14. The camu camu food product of claim 12, wherein said food product is enriched in at least L-arginine and vitamin C.

15. The camu camu food product of claim 14, said food product further enriched in ellagic acid, flavonoids or polyphenolics or a combination thereof.

16. A process for preparing an arginine-enriched Camu camu nutraceutical, comprising:
pureeing skin, pulp and seeds of a camu camu fruit;
spreading a layer of puree onto an infrared-transparent surface floating on water that is circulated and heated to a temperature less than boiling; and
radiating thermal energy through the infrared-transparent surface and the puree to evaporate the water therefrom to form a dry powder extract, said dry powder extract comprising the arginine-enriched camu camu nutraceutical.

17. The process of claim 16, further comprising milling the dry powder extract to reduce particle size thereof to increase dissolvability and a faster absorption.

18. The method of claim 16, wherein during the radiating step, temperature of the puree as the water evaporates therefrom does not exceed 96° F.

19. An arginine-enriched camu camu nutraceutical produced by the process of claim 16.

20. The arginine-enriched camu camu nutraceutical of claim 19, said nutraceutical further enriched with vitamin C, ellagic acid, flavonoids or polyphenolics or a combination thereof.

21. A nutraceutical prepared from a puree of pulp, skin and seeds of a camu camu fruit to retain an entirety of nutrients therein via a thermal condensing of the puree at a low temperature to form a dry powder.

22. The nutraceutical of claim 21, wherein the dry powder retains arginine and ascorbic acid.

23. The nutraceutical of claim 22, wherein the dry powder further retains at least one of ellagic acid, flavonoids or polyphenolics.

24. The nutraceutical of claim 21, wherein the nutraceutical is prepared at the low temperature of 96° F. or less.

25. The nutraceutical of claim 21, wherein the nutraceutical is contained in a food product as a component thereof.
